(19) United States
(12) Patent Application Publication
(10) Pub. No.: US 2006/0158882 A1
(43) Pub. Date: Jul. 20, 2006

(54) Led assembly

(75) Inventors: Maikel Albert Walther Klomp, Eindhoven (NL); Constance J.E. Saalberg-Seppen, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., BA Eindhoven (NL)

(21) Appl. No.: 10/526,305

(22) PCT Filed: Sep. 3, 2003
(86) PCT No.: PCT/IB03/03829

§ 371 Date: Mar. 2, 2005

(30) Foreign Application Priority Data
Sep. 6, 2002 (EP) 02078672.9

(51) Int. Cl. F21V 11/00

(52) U.S. Cl. 362/240

(57) ABSTRACT

The invention is related to LED assembly suitable to form a string provided with an LED mounted with a mounting on a base, which base is provided with electric connection wires wherein the LED mounting and electric contacts to the connection wires are protected from the surroundings by a package of hot melt material. The invention further relates to a string of interconnected LED assemblies, preferably wherein the LED assemblies are separated from each other by length of flexible contact wires.

The invention is related to an LED assembly provided with an LED and contact wires.

The invention further relates to a string of interconnected LED assemblies and to a plurality of thus formed strings.

In a string the LED assembly forms an LED repetition unit.

The LED-technology offers specific advantages for applications: robustness, low energy consumption, operating at low voltage, and a long life. As a consequence products are being offered in the market, that can replace e.g. neon in a channel letter application.

For many of the outdoor applications it is required that the lighting part is outdoor proof. As an example: the channel letters only give protection to direct water jets, but do not have an IP classification. At present these LED-based channel letter solutions when installed in outdoor channel letters cause failures related to corrosion of electrical contacts if no specific precautions are taken. In more quality-concerned solutions special precautions are taken, amongst others the embedding of the products for instance in epoxy, spraying the electrical contacts with lacquers or applying IP classified connectors to all the electrical contacts of each LED assembly.

Depending on the chosen outdoor protection, different drawbacks exist.

Once the configuration has been embedded, for instance in epoxy, it is impossible to adapt the lay-out of the lighting component, without causing damage to the configuration. Moreover, for the above-given example of a channel letter the epoxy is not only at the positions to embed and protect the connections, it is present at the complete bottom of the channel letters, which also means a spill of epoxy. Furthermore this is a rather time-consuming, and thus an expensive approach.

By spraying the electrical contacts with lacquers only a low IP-class protection can be achieved, whilst this is a labour-intensive approach, of which the quality is completely depending on the accuracy of the worker involved.

As for applying IP classified connectors to all the electrical contacts this is an expensive approach as only few contacts need to be of non-permanent character. Furthermore, if the IP classified connectors are not pre-installed in the lighting component, the approach is also particularly labour-intensive, and therefore even more expensive. This approach is not tolerant with respect to the use of different types of LEDs.

From EP0818652 a string of LED assemblies is known wherein the LED assembly is provided with a coloured or light transparent polycarbonate housing. Polycarbonates have the drawback of a relative high processing temperature and when once applied being relatively inelastic.

US 2002/0149948 discloses the possibility to encapsulate a single LED mounted on a printed board and a connector terminal in a hot melt resin.

It is the object of the invention to provide for a LED assembly suitable to form a string, which assembly counteracts the above stated drawbacks. According to the invention the LED assembly, which is suitable to form a string, is provided with an LED mounted with a mounting on a base, which base is provided with electric connection wires wherein the LED mounting and electric contacts to the connection wires are protected from the surroundings by a package of hot melt material. As an advantageous consequence the amount of additional material is much reduced for obtaining an outdoor proof version of the LED assembly and a string formed of a plurality of such LED assembly. Only where non-permanent contacts are desired, IP classified connectors will have to be applied. Therefore, this will result in intrinsically cheaper LED strings than is the case with the above-mentioned known configurations. Thus it is advantageously possible to have a LED assembly and a string formed by a plurality of such LED assemblies, which has a protection classification of IP 54 or IP 67.

In a further preferred embodiment the LED assembly according to the invention incorporates one or more electric components for instance for local control.

A further advantageous aspect is the possibility to use a Printed Circuit Board (PCB) forming the base with electrical contacts. This is in itself a standard and proven technology, which means that it is relatively cheap to perform and requires relatively low investments. Moreover, this approach is tolerant with the use of different types of LEDs.

Providing a package of hot melt to the base with mounted LED and electric connections is a production process that is particular suitable for large scale industrial application, in which the quality can be set and controlled.

In a preferable LED assembly according to the invention, the base has a front side on which the LED mounting is present and a backside section which is free of the hot melt package material. This embodiment is particular suitable for use of a metal based PCB, in which the metal base forms the back side section being free of the hot melt package material and thus able to provide cooling during operation of the LED. Advantageously this type of LED assembly is employed with the use of high power LEDs.

Preferably the light-emitting surface of the LED is kept outside the packaging as to prevent as much as possible any light loss. The hot melt material can be black, coloured or transparent for light. In a preferred embodiment of a LED assembly according to the invention the hot melt material has a white, light scattering surface. In this way loss of light, either by absorbing through the hot melt material or by the base is successfully counteracted. Not only the overall lighting efficacy of the resulting product comprising the LED assembly is advantageously improved, but in case of channel lettering for instance, it has also an advantageously effect on the evenly distribution of the light emission over the letter channel surface.

In a preferred embodiment of a string formed by a plurality of LED assemblies according to the invention the LED assemblies are separated from each other by length of flexible contact wires. In this way it is still possible to change the spacing between the LED-boards by shortening, for instance through bending the contact wires or lengthening the contact wires by inserting an extra length of wire between successive LED repetition units.

The invention will now be explained in more detail with reference to a drawing of embodiments, in which:

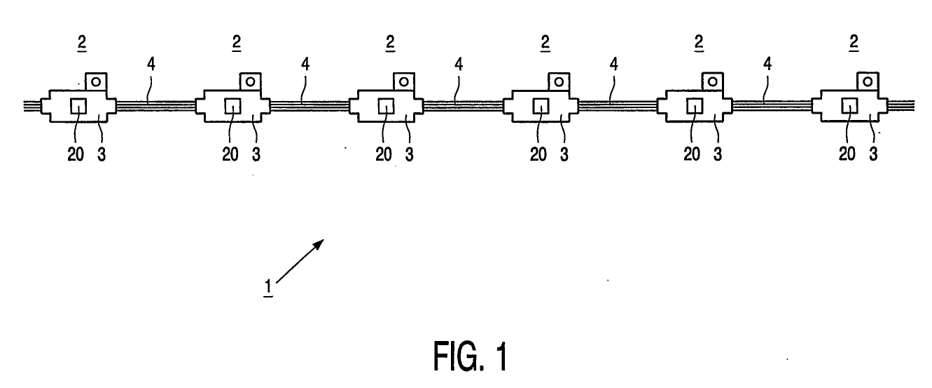

FIG. 1 is a 1^{st} embodiment of a string of LED assemblies according to the invention;

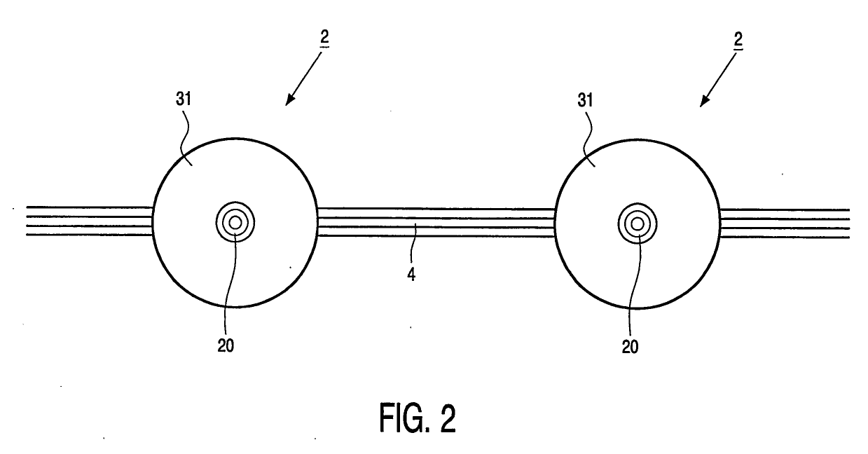

FIG. 2 is a frontal view of a 2^{nd} embodiment according to the invention, and

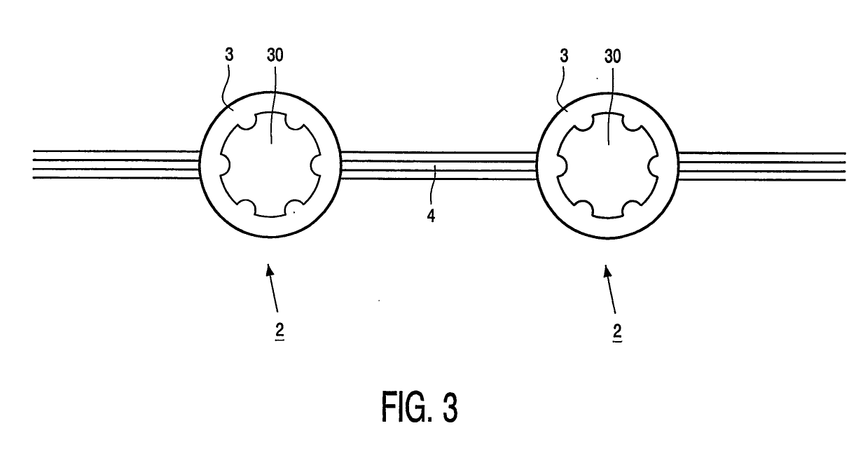

FIG. 3 is an opposite view of the embodiment from FIG. 2.

In FIG. 1 numeral 2 is a LED assembly formed into a string 1 provided with an LED 20 mounted with a mounting on a base, which base is provided with electric connection wires 4 wherein the LED mounting and electric contacts to the connection wires are protected from the surroundings by a package 3 of hot melt material. The connection wires 4 also provide for separation of the LED assemblies from each other in the string 1 by length of flexible contact wires.

In FIG. 2 a 2^{nd} embodiment of a LED assembly 2 is shown at the light emitting surface of the LED 20 being the frontal side 31 of the hot melt package of the LED assembly. In FIG. 3 is shown the side of the LED assembly, which is opposite the frontal side 30. In this embodiment the base is formed by a metal-based PCB having a backside section 30 which is free of the hot melt package material. In this way the metal base of the PCB can provide for cooling of the mounted LED and possible further electric components of the LED assembly. The shown embodiments are suitable for use in channel letters, but are not restricted to that application. Examples of other application areas are LED-based light lines for decorative or guiding purposes.

A suitable material for hot melt as basic component of the packaging is Termelt 868, make Bostik Findley, which packaging can be formed by dispensing techniques.

Preferably a string is formed by a repetition of LED assemblies separated from each other by a length of flexible contact wires. Typical dimensions of an LED assembly are 1 cm wide and 2 to 3 cm long. In height it may vary between several mm to over a cm, in the shown 1^{st} embodiment 1.2 cm. The assemblies are mounted in the string for instance on a separation of 5 cm. As the contact wires are flexible the actual distance between successive LEDs in the final application can be varied according to wish. Such a string can be formed to a roll or coil being advantageous for further handling.

A string can for instance contain 1200 LED assemblies.

In a further embodiment of the invention the LED assemblies are electrically arranged for instance in a matrix of 3 parallel strings each with an own colour of the LED, preferable red, green and blue.

Alternatively an LED assembly can contain more than 1 LED, for instance 3 LEDs of different colour.

A suitable base is for instance a printed circuit board (PCB). The PCB can hold besides the LED and the connections with the contact wire further electric components, like for instance for current limiting. Suitable in this respect is for instance a resistor. In a further embodiment the components can be formed by electronics, possibly provided with intelligence. This is in particular interesting for purposes of light and/or colour control, like for instance dimming.

With the invented LED assembly it is possible to achieve at least a protection level according to general accepted classification IP67.

1. LED assembly suitable to form a string and provided with an LED mounted with a mounting on a base, which base is provided with electric connection wires wherein the LED mounting and electric contacts to the connection wires are protected from the surroundings by a package of hot melt material.

2. LED assembly according to claim 1 wherein the hot melt material of the assembly provides for a protection according to at least IP 54.

3. LED assembly according to claim 1 wherein the assembly contains a plurality of LEDs.

4. LED assembly according to claim 1 wherein the assembly incorporates one or more electric components for local control.

5. LED assembly according to claim 1 wherein the hot melt material has a white, light scattering surface.

6. LED assembly according to claim 1 wherein the base has a front side on which the LED mounting is present and a back side section which is free of the hot melt package material.

7. A string formed by a plurality of LED assemblies as claimed in claim 1 wherein the LED assemblies are separated from each other by length of flexible contact wires.

8. A plurality of strings each according to claim 6, which strings are electrically arranged as forming a matrix.
